(19) United States
(12) Patent Application Publication
(10) Pub. No.: US 2010/0275457 A1
(43) Pub. Date: Nov. 4, 2010

(54) HOUSEHOLD APPLIANCE WITH A HEAT PUMP

(75) Inventors: Pilar Balerdi Azpilicueta, Barindano (Navarra) (ES); Iñigo Berazaluce Minondo, Pamplona, Spanien (ES); Roberto San Martin Sancho, Estella (ES)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/528,336

(22) PCT Filed: Feb. 12, 2008
(86) PCT No.: PCT/EP2008/051636

§ 371 Date: Aug. 24, 2009

(30) Foreign Application Priority Data
Mar. 2, 2007 (EP) 07004370.8

(51) Int. Cl. F26B 19/00; D06F 58/04; F25B 27/00

(52) U.S. Cl. 34/86; 34/130; 62/238.7

(57) ABSTRACT

The invention relates to a household appliance 1 comprising a drying chamber 2 for drying wet articles 3 therein, a process air loop 4 for circulating process air to dry the articles 3 and a heat pump 8, 9, 10, 11, 12. Said heat pump 8, 9, 10, 11, 12 comprises a pumping loop 8 containing a pumping fluid to be circulated through said pumping loop 8, an evaporator heat exchanger 9 for transferring heat from the process air into said pumping fluid by evaporating said pumping fluid, a liquefier heat exchanger 10 for transferring heat from said pumping fluid to the process air by liquefying said pumping fluid, a compressor 11 for compressing the pumping fluid and driving the pumping fluid through said pumping loop 8, and a nozzle 12 for decompressing said pumping fluid. Said pumping fluid has a critical temperature between 60° C. and 100° C., and a nominal heat of vaporization at boiling point of at least 220 kJ/kg. Further, said compressor 11 is configured for cooling by said pumping fluid after being compressed. Preferably, the household appliance 1 is a dryer 1 for drying wet laundry 3.

The invention relates to a household appliance comprising a drying chamber for drying wet articles therein, a process air loop for circulating process air to dry the articles and a heat pump, said heat pump comprising a pumping loop containing a pumping fluid to be circulated through said pumping loop, an evaporator heat exchanger for transferring heat from the process air into the pumping fluid by evaporating said pumping fluid, a liquefier heat exchanger for transferring heat from said pumping fluid to the process air by liquefying said pumping fluid, a compressor for compressing said pumping fluid and driving said pumping fluid through said pumping loop, and a nozzle for decompressing said pumping fluid, and wherein said pumping fluid has a critical temperature between 60° C. and 100° C., and a nominal heat of vaporization at boiling point of at least 220 kJ/kg.

A household appliance of this type is apparent from EP 1 593 770 A2. That known appliance is configured as a dryer for drying wet articles that are wet laundry. The process air loop is partially open to an ambient of the appliance to allow for partial discharging of process air from the loop and replacement of the process air discharged by air taken from the ambient. A preferred embodiment of the known appliance is disclosed wherein the pumping fluid used in the heat pump is the well-known refrigerant R22 that meets the requirements specified in the introductory chapter above. As to the compressor used, no specification as to its type or mode of operation is given.

Another household appliance for drying wet articles and comprising a heat pump as specified above, however without a particular pumping fluid being specified, is apparent from EP 0 467 188 B1. That document contains a detailed description of a household appliance that is configured as a dryer for drying articles which are wet laundry. The process air loop specified is substantially closed to an ambient of the dryer, with the term “substantially closed” being understood to mean that no considerable exchange of air between the process air loop and the ambient is allowed in general during operation of the dryer. This feature may be essential for the appliance to comply with pertinent standards that pertain to limiting leakage of humidity extracted from the articles to be dried into the appliance's ambient. The document refers to many details of the household appliance that may be necessary or at any rate advantageous in making or using the appliance. Accordingly, the whole content of this document is incorporated herein by reference.

EP 1 493 860 A2 discloses a household appliance of the type disclosed in the documents referred to above and comprising a heat pump that uses carbon dioxide or R744 as a pumping fluid and a rotary compressor for its compression. Carbon dioxide is a pumping fluid that has attained much consideration in recent years as it complies well with requirements from aspects relating to protecting the environment, but it is also particularly difficult to apply by requiring relatively high internal pressures in the pumping loop and by its remarkably low critical temperature of 31° C. only. It may be noted that application of carbon dioxide as a pumping fluid in a drying process as specified below will require to handle the pumping fluid at a temperature that is well above the critical temperature, meaning that the pumping fluid cannot be readily liquefied without a prior considerable extraction of heat from the fluid's gaseous phase.

CH 690 038 A5 discloses a household appliance that is in many aspects similar to the appliance disclosed in EP 1 593 770 A2 and has a heat pump that contains R407C, which is a mixture of fluorocarbon-based compounds and meets the requirements specified in the introductory chapter above, as a pumping fluid.

Related art for household appliances is apparent from documents WO 2006/029953 A1 that specifies a dishwasher in relation to a laundry dryer or combined laundry washer and dryer, DE 197 38 735 C2 that discloses a household appliance with a different type of heat pump, EP 1 672 294 A2, and EP 1 672 295 A2, the latter two disclosing air conditioning devices that have cooling circuits which are in some aspects similar to the heat pump considered herein incorporated therein.

Drying of wet articles in a household appliance generally requires evaporating the humidity on the articles and transporting away by means of a current of heated process air. Such process air loaded with evaporated humidity may be discharged from the appliance, or subjected to a condensation process to recover the transported humidity in liquid form for collection and disposal. Such condensation process in turn required to cool the process air, thereby extracting heat. That heat may again be discharged from the appliance simply; in order to keep consumption of energy low however, it may be desired to recover that heat at least to an extent. To that end, a household appliance has been developed that incorporates a heat pump which recovers energy taken from the process air by evaporating a pumping fluid, subsequently compressing that pumping fluid and releasing heat from it back into the process air which circulates in an essentially closed loop. While it may be expedient or even required to open such process air loop at least occasionally as described in EP 0 467 188 B1, pertinent IEC standards require that a dryer that is claimed to recover humidity by condensation keep any leakage of humidity below 20% of the total humidity present. Problems still to be encountered with such household appliances incorporating heat pumps are high manufacturing costs on one hand and relatively long periods needed to dry convenient charges of laundry or the like.

The pickup of humidity from articles to be dried by process air is only effective if the process air is heated over any normal ambient temperature, preferably to a temperature higher than 60° C. That temperature will be brought down by the evaporation process to a somewhat lower temperature. At any rate, a temperature around or above 35° C. at an inlet of an evaporator heat exchanger may be expected to pose a problem to a heat pump of the type specified in the introductory chapter and designed in accordance with practice common in the art of refrigeration, in that compressors and refrigerant fluids (generally specified as “pumping fluids” herein) from normal refrigeration practice are not suitable for the purpose. It has been considered to obtain relief by reverting to refrigerants of remarkably high critical temperatures so as to ascertain their function at working temperatures up to 60° C., but no thorough analysis is available so far. Other measures that have been applied to obtain relief are bringing excess heat out of the appliance, by exhaling warm process air in exchange for cooler air and including additional heat exchangers to take excess heat from the pumping fluid. All of these measures, however, introduce further complexity and cost.

Accordingly, it is an object of the invention to specify a household appliance as defined in the introductory chapter herein that has a heat pump which is detailed in a way so as to alleviate the problems specified above and allows for quicker drying of articles at an appropriate expense.

The present invention provides a solution embodied in the household appliance as defined in the independent claim. Preferred embodiments of the invention are defined in the dependent claims.

According to the invention, there is specified a household appliance comprising a drying chamber for drying wet articles therein, a process air loop for circulating process air to dry the articles and a heat pump, said heat pump comprising a pumping loop containing a pumping fluid to be circulated through said pumping loop, an evaporator heat exchanger for transferring heat from the process air into said pumping fluid by evaporating said pumping fluid, a liquefier heat exchanger for transferring heat from said pumping fluid to the process air by liquefying said pumping fluid, a compressor for compressing said pumping fluid and driving said pumping fluid through said pumping loop, and a nozzle for decompressing said pumping fluid, wherein said pumping fluid has a critical temperature between 60° C. and 100° C., and a nominal heat of vaporization at boiling point of at least 220 kJ/kg, and wherein said compressor is configured for cooling by said pumping fluid after being compressed.

According to the invention, a compressor is combined to a dedicated selection of a pumping fluid, the compressor being characterized by a special mode of dissipating excess heat generated therein. It is noted that a widely-known mode of cooling a compressor is arranged by enclosing the compressor in a sealed housing that is filled with the relatively cool gaseous pumping fluid flowing in from the evaporator. The compressor sucks in pumping fluid for compression from the inside of the housing, and ejects compressed fluid into a line that is connected to the liquefier. Thus, cooling is provided by the pumping fluid prior to its compression, with the pumping fluid being heated by the compressor's excess heat. In accordance with the invention, it has been understood that such generally known mode of cooling the compressor implies a negative effect on the operation of the compressor itself, by such heating the pumping fluid prior to compression. Accordingly, it has been determined in accordance with the invention that a compressor is applied that effects cooling of the compressor with the pumping fluid after being compressed. This is a paradoxical solution since it implies that the operational temperature level of the compressor according to the invention is considerably higher than that of a compressor that is cooled according to well-known prior art.

In accordance with the invention, it has been found that a dedicated combination of a compressor having a particularly high efficiency and a pumping fluid that needs not have a particularly high critical temperature but has a remarkably high volumetric heat capacity to absorb heat from the humid process air provides an effective basis for the household appliance sought. If the level of critical temperature introduces a concern about the efficiency of the heat pumping process to be established in the appliance, the concern is mitigated by the high efficiency of the compressor. In addition, the predominantly high nominal heat of vaporization at boiling point (to be determined at normal pressure, namely 1 bar or 101.3 kPa) of the pumping fluid assures that heat can be absorbed from the process air effectively and at a limited increase in temperature, thereby preventing the heat pump from generating excess temperatures and endangering the pumping process to become dysfunctional as the critical temperature of the pumping fluid is surpassed somewhere in the heat pump. The effective absorption of heat by the pumping fluid also promotes acceleration of the drying process as a whole, so as to alleviate the problem of long duration of the drying process as experienced in prior art appliances with heat pumps.

It is noted that the invention encompasses a selection of the pumping fluid from a group of compounds known as such and comprising the known halomethane R22 that contains both chlorine and fluorine, and the known alkane R290 or propane. As to R22, it is discouraged for further use by its properties in contributing to ozone-layer depletion. As to propane, its pertinent physical properties make it highly suitable for the present purpose indeed, and it is noted that propane has already been used in commercially used refrigeration systems. Of course, application of propane which is highly flammable will require dedicated protection of the systems included in the pumping loop against any fire hazard.

The invention requires the use of a compressor that is configured for cooling by said pumping fluid after being compressed, which may be provided particularly for common rotary compressors. In a rotary compressor, the pumping fluid being compressed is kept at a steady flow without vortices and other discontinuities occurring at a major extent. Most important, excess import of heat into the pumping fluid prior to being compressed is avoided, which results in an overall improvement of the figure of merit of the compression process. In addition, the reduced temperature of the pumping fluid admitted for compression results in a larger mass flow within the pumping loop, yielding a further improvement in heat transport capacity, or allowing use of a somewhat smaller compressor. On one hand, such improved compressor, in particular rotary compressor will be somewhat more costly than a more usual compressor with a machine having reciprocating pistons. On the other hand, such improved compressor keeps any additional heating of the pumping fluid predominantly low, thereby mitigating excess temperatures within the heat pump.

In a preferred embodiment of the invention, the household appliance's drying chamber is a rotatable drum. More preferred, that household appliance configured as a dryer for drying wet laundry.

In another preferred embodiment of the invention, the compressor is a rotary compressor. Even more preferred, the compressor is a turbocompressor.

In a further preferred embodiment of the invention, the pumping fluid has a critical temperature between 70° C. and 90° C.

In yet another preferred embodiment of the invention, the pumping fluid has a nominal heat of vaporization at boiling point between 230 kJ/kg and 440 kJ/kg.

In yet a further embodiment of the invention, the pumping fluid comprises at least one fluorinated hydrocarbon compound. Still further preferred, such pumping fluid is selected from the group consisting of refrigerants R407C and R410A as specified under pertinent ASHRAE or DIN 8960 standards.

In still another preferred embodiment of the invention, the heat pump has a nominal cooling power between 500 W and 3.500 W, thus complying with needs established for application in a household appliance determined to dry wet laundry. Yet more preferred and also in view of the application just specified, the heat pump has a nominal cooling power between 1.500 W and 3.000 W.

In still a further preferred embodiment of the invention, the evaporator heat exchanger has a nominal process air inlet temperature of at least 35° C., thus allowing application of the invention in a household appliance at predominantly high level of temperature, well above levels as usual in refrigeration of air conditioning systems.

In yet another preferred embodiment of the invention, the liquefier heat exchanger has a nominal process air outlet temperature of less than 70° C.; thereby it is demonstrated that the invention incorporates a particularly high degree of temperature control within the heat pump, to alleviate any need for additional temperature control in a household appliance where the heat pump has to operate at a predominantly high level of temperature, without an apparent need to resort to additional heat exchangers or other means to dispose of excess heat.

An exemplary preferred embodiment of the invention is now described with reference to the accompanying drawing, wherein:

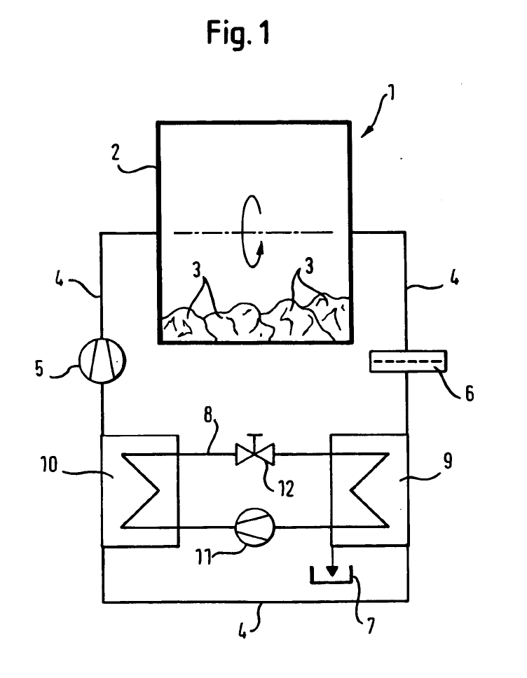

FIG. 1 shows a household appliance configured as a dryer for drying laundry; and

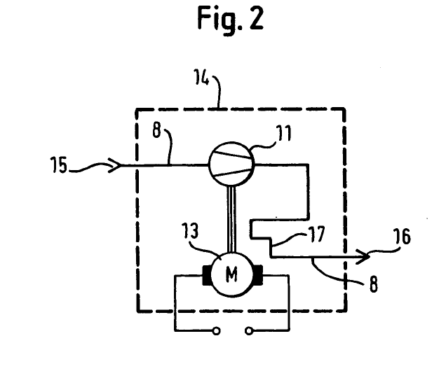

FIG. 2 shows a compressor configuration.

The drawing has to be understood to be a sketch showing only such details as are necessarily required for the description subsequent hereto. For further details and indications on how to put the invention into practice, reference is made to the prior art documents cited herein and the pertinent knowledge of the person skilled in the art.

FIG. 1 shows a household appliance 1 embodied as a dryer 1 for drying laundry wet 3. It should be noted that such dryer 1 may be an appliance determined for drying solely, or an appliance determined both for washing and drying.

The dryer 1 comprises a drying chamber 2 embodied as a rotatable drum 2 for retaining wet laundry 3 to be dried by a flow of process air circulating in a closed process air loop 4. Process air is driven in a clockwise direction through said process air loop 4 by a blower 5. It should be noted that the placing of the blower 5 directly adjacent to the drum 2 is only exemplary. Subsequent to traversing the drum 2, the process air having taken up humidity from the laundry 3 being tumbled by rotation of the drum 2 traverses a lint filter 6, in order to catch lint released from the laundry 3 and prevent further components within the process air loop 4 from clogging. By cooling the process air after having traversed the lint filter 7, humidity contained therein is brought to condensation; condensate thus obtained is stripped from the process air and collected in condensate collector 7 for disposal after the drying process has been accomplished. Subsequent to cooling and removal of condensate, the process air is heated again and conveyed back to the drum 2 by blower 5, to pick up more humidity and thus dry the laundry 3.

Sequential cooling and heating of the process air circulating in the process air loop 4 are accomplished by a heat pump 8, 9, 19, 11, 12 comprising a pumping fluid loop 8 that contains a pumping fluid or refrigerant, preferably one of the fluorinated hydrocarbon compound mixtures R407C and R410A. The pumping fluid is circulated through evaporator heat exchanger 9 and liquefier heat exchanger 10. In evaporator heat exchanger 9, the pumping fluid absorbs heat from the process air carrying humidity take up in the drum 2. The resulting cooling of the process air results in that humidity condensates to be stripped off and conveyed to condensate collector 7 for later disposal. Details of this are well known in the art and are not detailed in FIG. 1 accordingly.

The resulting heating of the pumping fluid which reaches the evaporator heat exchanger 9 in liquid phase results in the pumping fluid to evaporate. The pumping fluid leaves the evaporator heat exchanger 9 in gas phase through a respective portion of the pumping loop 8 and reaches the compressor 11 which is a rotary compressor 11. Such rotary compressor 11 is available as a staple commercial product and detailed to some extent in FIG. 2, as explained hereinbelow. In the compressor 11, the pumping fluid is compressed and forwarded to the liquefier heat exchanger 10, where it transfers heat to the process air arriving from the evaporator heat exchanger 9 as well, and condensates to its liquid state again. Subsequently, the pumping fluid passes a nozzle 12 where it is decompressed to a lower pressure level, to enter the evaporator heat exchanger 9 again for absorbing more heat from the process air arriving from the lint filter 6, to complete its circle. After having absorbed heat in the liquefier heat exchanger 10, the process air is conveyed back to the drum 2 to absorb more humidity from the laundry 3, to complete its own circle.

Preferred temperature ranges for the pumping fluid or the process air have been specified hereinbefore and are not repeated at this point.

Details of an arrangement comprising the rotary compressor 11 are shown in FIG. 2. Accordingly, the compressor 11 in itself is driven by an electric motor 13. The compound of the compressor 11 and the motor 13 is contained in a housing 14, and traversed by the pumping loop 8 from an inlet 15 to an outlet 16. The housing 14 also contains an internal cooler 17 for cooling the motor 13 and the compressor 11. That cooler 17 is fed by pumping fluid exiting the compressor 11, according to common practice for rotary compressors 11. In contrast to usual practice with reciprocating compressors, the pumping fluid upon entry via the inlet 15 does not flood the whole of the housing 14 prior to admission into the compressor 11, so as to provide cooling for the motor 13 and mechanical parts of the compressor 11. That type of cooling, though quite effective in general, provides for heating up the pumping fluid prior to its compression and thus impairs the effectivity of the compression process. Accordingly, resort is made presently to cooling the motor 13 and the compressor 11 by pumping fluid after compression, which introduces its own limitations but assures an effective compression process, which improves the heat pumping process in turn.

At any rate, the household appliance having a heat pump as disclosed herein features a specific selection of functional components of the heat pump that assures a delicate balance of heat generation and transfer in application to a drying purpose and related operation, to assure smooth and highly efficient operation at a properly limited expense in manufacturing and operation.

### LIST OF REFERENCE NUMERALS

1 Household appliance, dryer
2 Drying chamber, drum
3 Wet articles, laundry
4 Process air loop
5 Blower
6 Lint filter
7 Condensate collector
8 Pumping loop
9 Evaporator heat exchanger
10 Liquefier heat exchanger
11 Compressor
12 Nozzle
13 Drive motor
14 Compressor housing
15 Compressor inlet
16 Compressor outlet
17 Internal cooler

1. Household appliance (1) comprising a drying chamber (2) for drying wet articles (3) therein, a process air loop (4) for circulating process air to dry the articles (3) and a heat pump (8, 9, 10, 11, 12), said heat pump (8, 9, 10, 11, 12) comprising a pumping loop (8) containing a pumping fluid to be circulated through said pumping loop (8), an evaporator heat exchanger (9) for transferring heat from the process air into said pumping fluid by evaporating said pumping fluid, a liquefier heat exchanger (10) for transferring heat from said pumping fluid to the process air by liquefying said pumping fluid, a compressor (11) for compressing said pumping fluid and driving said pumping fluid through said pumping loop (8), and a nozzle (12) for decompressing said pumping fluid, and wherein said pumping fluid has a critical temperature between 60° C. and 100° C., and a nominal heat of vaporization at boiling point of at least 220 kJ/kg, characterized in that said compressor (11) is configured for cooling by said pumping fluid after being compressed.

2. Household appliance (1) according to claim 1, wherein said drying chamber (2) is a rotatable drum (2).

3. Household appliance (1) according to claim 2, which is configured as a dryer (1) for drying wet laundry (3).

4. Household appliance (1) according to one of the preceding claims, wherein said compressor (11) is a rotary compressor (11).

5. Household appliance (1) according to claim 4, wherein said compressor (11) is a turbocompressor (11).

6. Household appliance (1) according to one of the preceding claims, wherein said pumping fluid has a critical temperature between 70° C. and 90° C.

7. Household appliance (1) according to one of the preceding claims, wherein said pumping fluid has nominal heat of vaporization at boiling point between 230 kJ/kg and 440 kJ/kg.

8. Household appliance (1) according to one of the preceding claims, wherein said pumping fluid comprises at least one fluorinated hydrocarbon compound.

9. Household appliance (1) according to claim 8, wherein said pumping fluid is selected from the group consisting of refrigerants R407C and R410A.

10. Household appliance (1) according to one of the preceding claims, wherein said heat pump (8, 9, 10, 11, 12) has a nominal cooling power between 500 W and 3.500 W.

11. Household appliance (1) according to claim 11, wherein said heat pump (8, 9, 10, 11, 12) has a nominal cooling power between 1500 W and 3.000 W.

12. Household appliance (1) according to one of the preceding claims, wherein said evaporator heat exchanger (9) has a nominal process air inlet temperature of at least 35° C.

13. Household appliance (1) according to one of the preceding claims, wherein said liquefier heat exchanger (10) has a nominal process air outlet temperature of less than 70° C.
